(19) United States
(12) Patent Application Publication
(10) Pub. No.: US 2001/0029176 A1
(43) Pub. Date: Oct. 11, 2001

(54) Portable cellular phone system, method for controlling same and storage medium storing control program for conrtolling same

(76) Inventor: Keiichi Taniguchi, Tokyo (JP)

Correspondence Address: SUGHRUE, MION, ZINN, MACPEAK & SEAS, 2100 Pennsylvania Avenue, N.W., Washington, DC, 20037-3202, US

(21) Appl. No.: 09/825,332

(22) Filed: Apr. 4, 2001

(30) Foreign Application Priority Data
Apr. 5, 2000 (JP) 103302/2000

(51) Int. Cl. H04M 11/10

(52) U.S. Cl. 455/413; 455/415; 455/456; 455/567

(57) ABSTRACT

A portable cellular phone system is provided which is capable of notifying a portable cellular phone of a presence or absence of a voice message by using a radio packet communication system.

The voice message to be fed to a user of the portable cellular phone is sent out from a telephone by a caller's manipulation of the telephone. The voice message sent out from the telephone is transmitted through a dialup line and, when a location of the portable cellular phone has not been registered, is transferred to a voice server through a switching center. When the location of the portable cellular phone has been registered, a voice message arrival notifying signal is sent out from the voice server through the switching center and a base station to the portable cellular phone by using the radio packet communication system. The portable cellular phone notifies its user of receipt of the voice message.

### BACKGROUND OF THE INVENTION

1. Field of the Invention

The present invention relates to a portable cellular phone system enabling a user of a portable cellular phone to make use of a stored-type voice message service and more particularly to the portable cellular phone system having a function of notifying of an arrival of a voice message to the user of the portable cellular phone by using a radio packet communication system.

The present application claims priority of Japanese Patent Application No.2000-103302 filed on Apr. 5, 2000, which is hereby incorporated by reference.

2. Description of the Related Art

In a conventional portable cellular phone system, if a portable cellular phone is placed out of an area of service provided by the portable cellular phone system or if the portable cellular phone is put in an OFF state, or even if it is put in an ON state, when it is placed temporarily in an area where no radio signal from the portable cellular phone system reaches, even if there is a notification about an arrival of a voice message fed from the portable cellular phone system, since the notification cannot be retreived by the portable cellular phone, a user of the portable cellular phone cannot respond to the notification about the arrival of the voice message.

The conventional portable cellular phone system of this type includes, as shown in FIG. 5, a telephone set 1, a public switched telephone network (hereinafter referred to as a “dialup line”) 2, a switching center 3, a voice server 4, a base station 5 and a portable cellular phone 6. The telephone set 1 is connected to the switching center 3 through the dialup line 2 and conducts communication with the portable cellular phone 6. The switching center 3 controls a connected state of the dialup line 2. The voice server 4, when communication with the portable cellular phone 6 cannot be conducted due to some reasons, stores, for a specified period of time, a voice message sent out by the telephone set 1 to be fed to the portable cellular phone 6, in a voice message storing area 4m. The base station 5 is connected to the portable cellular phone 6 by radio and to the switching center 3 by a wire.

In the above conventional portable cellular phone system, for example, when the portable cellular phone 6 is placed out of the service area and a user of the telephone set 1 wants to make a call to the portable cellular phone 6, the user of the telephone set 1 first manipulates a dial of the telephone set 1 and then sends out a call signal to the portable cellular phone 6. At this point, if the portable cellular phone 6 is placed out of the service area, the switching center 3 recognizes that a location of the portable cellular phone 6 has not been registered. Because of this, though the call signal is transmitted from the telephone set 1 to the portable cellular phone 6 through the switching center 3 and the base station 5, the call signal is not transmitted from the base station 5 to the portable cellular phone 6 and is transferred from the switching center 3 to the voice server 4. A call acknowledge signal is transmitted from the voice server 4 through the switching center 3 to the telephone set 1.

The telephone set 1, after having received the call acknowledge signal transmitted from the voice server 4, enters a speech phase. Since the portable cellular phone 6 is placed out of the service area, a voice guidance prompting for registration of a voice message to be fed to a user of the portable cellular phone 6 is automatically provided to the user of the telephone set 1. The user of the telephone set 1, after having heard the voice guidance, has the voice message recorded in the voice message storing area 4m, which has been prepared in advance to store the voice message to be fed to the portable cellular phone 6. Since the location of the portable cellular phone 6 has not been registered with the base station 5, at the time when the voice message to be fed to the portable cellular phone 6 is newly recorded, the user of the portable cellular phone 6 cannot recognize that the voice message has been recorded. Moreover, since a notification that the voice message has been recorded is not provided by the voice server 4 to the user of the portable cellular phone 6, the user of the portable cellular phone 6 cannot judge whether the voice message to be fed to the portable cellular phone 6 has arrived or not. Therefore, the user of the portable cellular phone 6, after some time has elapsed since a new registration of the voice message to be fed to the portable cellular phone 6, has to make an inquiry of the voice server 4 about whether the voice message has been stored or not. That is, the user of the portable cellular phone 6, after having moved into the service area, manipulates the portable cellular phone 6 to transmit a signal to the voice server 4 for making inquiry about whether the voice message has been stored or not.

To do this, the user of the portable cellular phone 6, as in the case of an ordinary telephone call, manipulates a dial of the portable cellular phone 6 to designate a telephone number of the voice server 4 and to establish a connection with the voice server 4. Then, the user of the portable cellular phone 6 has to operate the portable cellular phone 6 in accordance with voice guidance fed from the voice server 4 to hear the stored voice message. Thus, the user of the portable cellular phone 6 can hear the voice message to be fed to himself/herself by the portable cellular phone 6.

However, the conventional portable cellular phone 6 described above has following problems:

(1) The user of the portable cellular phone 6, when making inquiries of the voice server 4 about the accumulation of the voice message, has to make a call to the voice server 4 using a speech channel designated in accordance with “RCR-STD-27H (Research & Development Center for Radio System-Standard 27H) being a specification for a standard portable cellular phone in Japan. That is, the user of the portable cellular phone 6 has to use the speech channel to check whether the voice message has been accumulated in the voice server 4 or not. As a result, there are some cases where the voice server 4 is forcedly put in a state in which a telephone call is in progress, thus interfering with use by other users.

(2) Though the user of the portable cellular phone 6 can distinguish whether there is the voice message or not, the user of the portable cellular 6 phone cannot get information about a party who has recorded the voice message through the voice server 4 because the user of the portable cellular phone 6 cannot know the party until he/she has heard the voice message accumulated in the voice server 4.

### SUMMARY OF THE INVENTION

In view of the above, it is an object of the present invention to provide a portable cellular phone system which is capable of preventing an increase in traffic of speech channels and which enables a user of a portable cellular phone to get information about a party who has recorded a voice message.

According to a first aspect of the present invention, there is provided a portable cellular phone system enabling a user of a portable cellular phone to make use of a stored-type voice message service including:

units to store, when connection with the portable cellular phone is unable to be made, a voice message to be fed to the portable cellular phone and to provide, when connection with the portable cellular phone is able to be made, a notification that the voice message has been stored, to the portable cellular phone.

In the foregoing, a preferable mode is one wherein the notification that the voice message has been stored is provided to the portable cellular phone by using a radio packet communication system.

According to a second aspect of the present invention, there is provided a portable cellular phone system enabling a user of a portable cellular phone to make use of a stored-type voice message service including:

a telephone set used to send out a voice message to be fed to a user of the portable cellular phone by manipulation of a caller of the telephone set;

a dialup line used to transmit the voice message;

a switching center used to transmit, when connection with the portable cellular phone is unable to be made, the voice message fed through the dialup line to a voice message storing device and to send out, when connection with the portable cellular phone is able to be made, a notification about an arrival of the voice message, by reading it from the voice message storing device;

the voice message storing device used to store the voice message transmitted from the switching center and to send out a voice message arrival notifying signal;

a base station used to send out the voice message arrival notifying signal fed from the switching center to the portable cellular phone; and

the portable cellular phone used to receive the voice message arrival notifying signal and to notify the user of the portable cellular phone of receipt of the voice message arrival notifying signal.

In the foregoing, a preferable mode is one wherein the base station is so configured as to transmit the voice message arrival notifying signal fed from the switching center to the portable cellular phone by using a radio packet communication system.

Also, a preferable mode is one wherein the voice message arrival notifying signal contains information about a caller and the portable cellular phone has a function to display the information about the caller.

According to a third aspect of the present invention, there is provided a method for controlling a portable cellular phone system enabling a user of a portable cellular phone to make use of a stored-type voice message service including:

steps of storing, when connection with the portable cellular phone is unable to be made, a voice message to be fed to the portable cellular phone and of providing, when connection with the portable cellular phone is able to be made, a notification that the voice message has been stored, to the portable cellular phone.

According to a fourth aspect of the present invention, there is provided a method for controlling a portable cellular phone system enabling a user of a portable cellular phone to make use of a stored-type voice message service including:

a voice message sending process of sending out a voice message to be fed to a user of the portable cellular phone by a manipulation of a caller of a telephone set;

a voice message transmitting process of transmitting the voice message;

a switching process of transmitting, when connection with the portable cellular phone is unable to be made, the voice message fed by the voice message transmitting process, to a voice message storing device and of sending out, when connection with the portable cellular phone is able to be made, a voice message arrival notifying signal informing that the voice message has been stored, by reading it from the voice message storing device;

a voice message storing process of storing the voice message fed by the switching process and of sending out the voice message arrival notifying signal;

a packet transmitting process of transmitting the voice message arrival notifying signal fed by the switching process to the portable cellular phone; and

a voice message arrival notifying process of receiving the voice message arrival notifying signal and of notifying the user of the portable cellular phone of receipt of the voice message arrival notifying signal.

In the foregoing, a preferable mode is one wherein the packet transmitting process is a process of transmitting the voice message arrival notifying signal fed by the switching process to the portable cellular phone by using a radio packet communication system.

Furthermore, a preferable mode is one wherein the voice message arrival notifying signal contains information about a caller and the voice message arrival notifying process contains a process of displaying the information about the caller.

According to a fifth aspect of the present invention, there is provided a storage medium storing a program to have functions of a portable cellular phone described above implemented in a computer.

With the above configurations, even if the portable cellular phone is placed out of a service area, after a voice message to be fed to the portable cellular phone has been stored in a voice server, when the portable cellular phone moves into the service area, a voice message arrival notifying signal is transmitted by using a radio packet communication system and, therefore, a user of the portable cellular phone can check whether there are voice messages stored in the voice server without using ordinary speech channels. This prevents the speech channels from being increased, thus enabling efficient use of the speech channels. Furthermore, since information about a caller is contained in the voice message arrival notifying signal and the information about the caller is displayed by the portable cellular phone, the user of the portable cellular phone can easily identify a party who has sent out the voice message.

### BRIEF DESCRIPTION OF THE DRAWINGS

The above and other objects, advantages and features of the present invention will be more apparent from the following description taken in conjunction with the accompanying drawings in which:

FIG. 1 is a schematic block diagram showing electrical configurations of a portable cellular phone system according to an embodiment of the present invention;

FIG. 2 is a schematic block diagram showing electrical configurations of a portable cellular phone according to the embodiment of the present invention;

FIG. 3 is a diagram showing a sequence of operations of the portable cellular phone system according to the embodiment of the present invention;

FIG. 4 is a diagram showing one example of a data format of a voice message arrival notifying signal according to the embodiment of the present invention; and

FIG. 5 is a schematic block diagram showing electrical configurations of a conventional portable cellular phone system.

### DETAILED DESCRIPTION OF THE PREFERRED EMBODIMENT

Best modes of carrying out the present invention will be described in further detail using various embodiments with reference to the accompanying drawings.

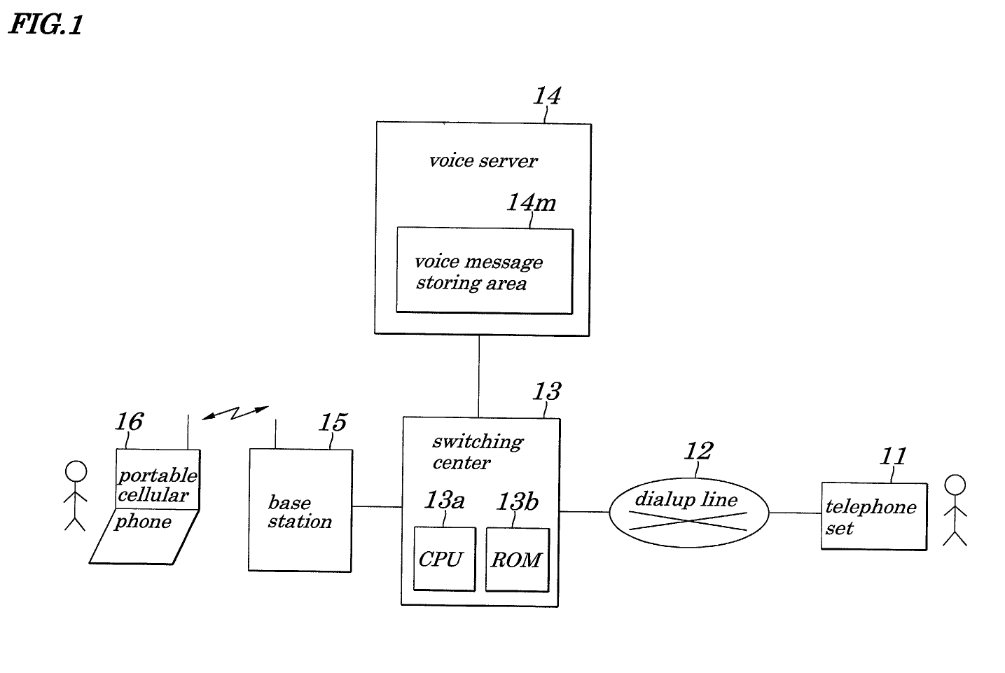

FIG. 1 is a schematic block diagram showing electrical configurations of a portable cellular phone system according to an embodiment of the present invention.

The portable cellular phone system of the embodiment includes a telephone set 11, a communication line (hereinafter called a dialup line) 12, a switching center 13, a voice accumulating device (hereinafter called a voice server) 14, a base station 15 and a portable cellular phone 16. The telephone set 11 connected to the switching center 13 through the dialup line 12 conducts communication with the portable cellular phone 16 and sends out a voice message to be fed to a user of the portable cellular phone 16 by an operation of a caller. The dialup line 12 transmits the voice message fed from the telephone set 11.

The switching center 13 has a CPU (Central Processing Unit) 13a used to control an entire switching center 13 and a storage medium such as a ROM (Read Only Memory) 13b used to store a control program to operate the CPU 13a. The switching center 13 manages a connected state of the dialup line 12, transfers, when a location area of the portable cellular phone 16 has not been registered, a voice message fed through the dialup line 12 to the voice server 14 and read, only when the location area of the portable cellular phone 16 has been registered, a voice message arrival notifying signal from the voice server 14 and transmits it to the switching center 13. The voice server 14, when connection with the portable cellular phone 16 is unable to be made due to some reasons, accumulates the voice message to be fed to the portable cellular phone 16 in a voice message storing area 14m for a specified period of time, which has been transmitted through the switching center 13 from the telephone set 11. Moreover, the voice server 14 has a function of transmitting the voice message arrival notifying signal to the switching center 13. The base station 15 is connected to the portable cellular phone 16 by radio and to the switching center 13 by a wire. The base station 15 has a function of transmitting the voice message arrival notifying signal fed from the switching center 13 to the portable cellular phone 16 by using a radio packet communication system. The portable cellular phone 16 receives the voice message arrival notifying signal transmitted from the base station 15 and notifies a user of the portable cellular phone 16 of the arrival of the voice message.

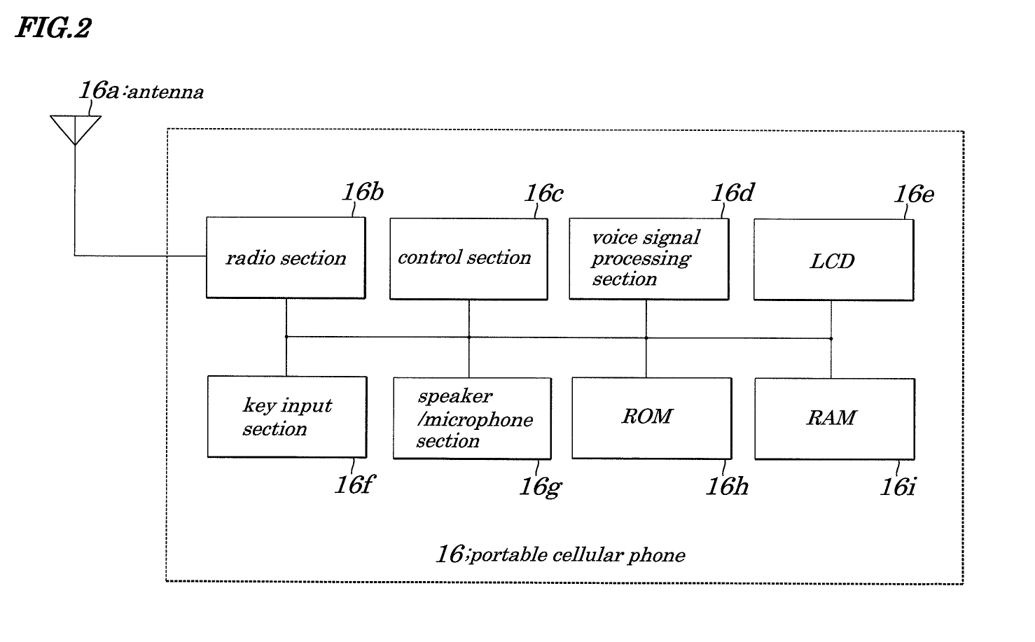

FIG. 2 is a schematic block diagram showing electrical configurations of the portable cellular phone 16 according to the embodiment of the present invention. The portable cellular phone 16 chiefly includes an antenna 16a, a radio section 16b, a control section 16c, a voice signal processing section 16d, an LCD (Liquid Crystal Display) section 16e, a key input section 16f, a speaker/microphone section 16g, a memory (such as a ROM) 16h and a memory (such as a RAM) 16i. The radio section 16b receives a radio signal via the antenna 16a. The control section 16c, which is made up of a CPU or a like, is adapted to control operations of the portable cellular phone 16 in accordance with a control program written, in advance, in the ROM 16h. The voice signal processing section 16d converts a signal of a voice recorded by the speaker/microphone section 16g to a digital signal and also converts a received digital signal to a voice signal and transmits to the speaker/microphone section 16g.

The LCD section 16e displays information including various messages for the user of the portable cellular phone 16. The key input section 16f is used to input various information by a manipulation of the user of the portable cellular phone 16 and to provide various instructions to operate the portable cellular phone 16. The speaker/microphone section 16g outputs voice signals converted from digital signals by the voice signal processing section 16d and inputs voice signals. The ROM 16h stores the control program which is used by the control section 16c to control the portable cellular phone 16. The control program is impossible to be rewritten by manipulations of an ordinary user of the portable cellular phone 16. The RAM 16i temporarily stores working data used for various operations of the control section 16c and temporarily stores information set by the user of the portable cellular phone 16. The portable cellular phone 16 is so configured as to be able to use two types of communication services including a wireless telephone communication function designated by a RCR-STD-27H being standard specifications in Japan and a radio packet communication function.

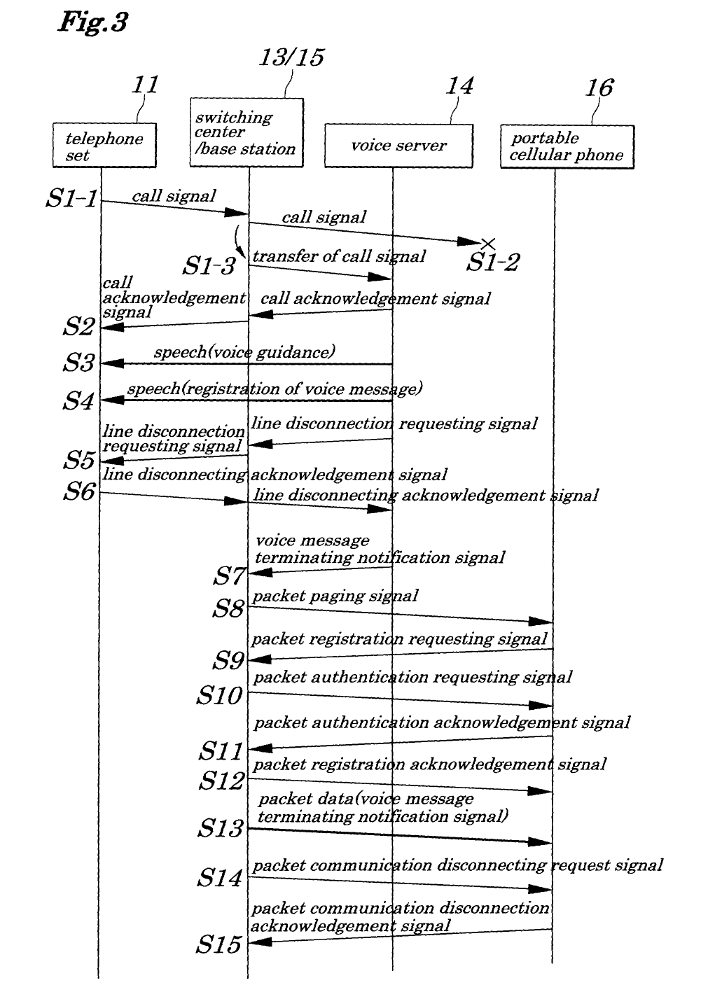

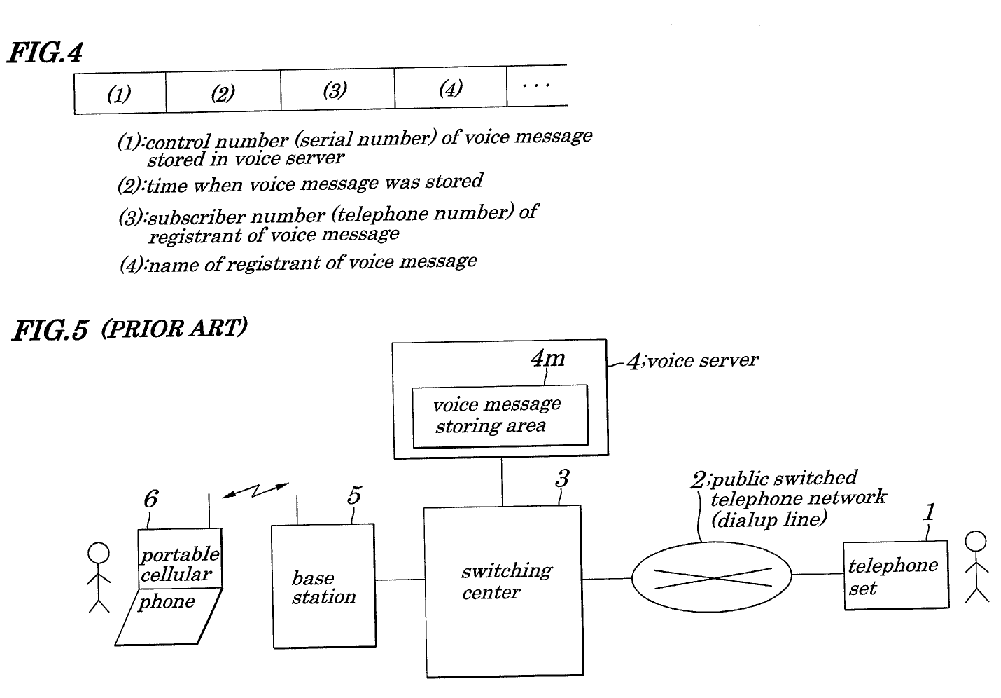

FIG. 3 is a diagram showing sequence of operations of the portable cellular phone system according to the embodiment of the present invention. FIG. 4 is a diagram showing one example of a data format of the voice message arrival notifying signal according to the embodiment of the present invention. Operations of the portable cellular phone 16 will be described by referring to FIGS. 3 and 4.

In the portable cellular phone system of the embodiment, while the portable cellular phone 16, for example, is placed out of a service area, if a user of the telephone set 11 wants to make a call to the portable cellular phone 16, the user of the telephone set 11 sends out a call signal to the portable cellular phone 16 by manipulating a dial of the telephone set 11. At this point, if the portable cellular phone 16 is out of the service area, the switching center 13 recognizes that a location of the portable cellular phone 16 has not yet been registered. In the registration processing of the location, while the portable cellular phone 16 itself recognizes that it is placed out of the service area (that is, the portable cellular phone 16 has not been registered), a signal requesting for registration of the location of the portable cellular phone 16 is transmitted to the switching center 13 from the portable cellular phone 16 at a specified time interval when the portable cellular phone 16 is placed in an ON state. The switching center 13, after having received the signal requesting for the registration of the location transmitted from the portable cellular phone 16, transmits a location registration acknowledgement signal to the portable cellular phone 16, thereby causing both the portable cellular phone 16 and switching center 13 to confirm that the portable cellular phone 16 is placed within the service area. However, if the portable cellular phone 16 is placed out of the service area, the location registration of the portable cellular phone 16 has not been registered. The switching center 13 judges whether the portable cellular phone 16 has been registered with the portable cellular phone system and whether a connection with the portable cellular phone 16 is possible or not. Therefore, in the above example, the telephone connection is not allowed because the portable cellular phone 16 is out of the service area.

If the user of the telephone set 11 (that is, a caller), under this circumstance, wants to place a call to the portable cellular phone 16, as shown in FIG. 3, first transmits a call signal to the portable cellular phone 16 by manipulating the dial of the telephone set 11 (Step S1-1). In the example, at this point, since the portable cellular phone 16 is placed out of the service area, the switching center 13 recognizes that the portable cellular phone 16 has not been registered. Therefore, though an attempt to transmit the call signal from the telephone set 11 through the switching center 13 and the base station 15 to the portable cellular phone 16 is made, the call signal is transferred from the switching center 13 to the voice server 14 (Step S1-3) without being transmitted from the base station 15 to the portable cellular phone 16 (Step S1-2). Then, the telephone set 11 receives a call acknowledgement signal transmitted from the voice server 14 through the switching center 13 and the dialup line 12 (Step S2) Thereafter, the telephone set 11 is connected to the voice server 14 via the dialup line 12 and they are placed in a state where a call is in progress. After the telephone set 11 and the voice server 14 have moved to a state where the call is in progress, a voice guidance prompting for registration of a voice message to be fed to the portable cellular phone 16 is provided from the voice server 14 to the telephone set 11 (Step S3).

The user of the telephone set 11, after having heard the voice guidance, records the voice message in the voice message storing area 14m in the voice server 14, which is prepared, in advance, to store voice messages to be fed to the portable cellular phone 16, for a specified period of time (that is, processing of transmitting and recording the voice message is performed). The recorded voice message is stored in the voice server 14 (that is, processing of accumulating the voice message is performed). Thus, the voice message to be fed to the portable cellular phone 16 is stored in the voice server 14 (Step S4). The voice server 14, after the voice message has been stored in the voice server 14, transmits a line disconnection requesting signal to disconnect the line to the switching center 13, base station 15 and telephone set 11 (Step S5), and the switching center 13, base station 15 and telephone set 11 transmit a line disconnection acknowledgement signal to the voice server 14 (Step S6).

Then, when the portable cellular phone 16 has moved into the service area, a voice message arrival notifying signal to notify the portable cellular phone 16 that the voice message to be fed to the portable cellular phone 16 has been stored in the voice server 14 is transmitted from the voice server 14 to the switching center 13. As a communication method for transmitting the voice message arrival notifying signal from the voice server 14 to the switching center 13, a TCP/IP (Transmission Control Protocol/Internet Protocol) being a communication protocol generally used for wired communications is used (Step S7). The voice message arrival notifying signal is received by the switching center 13 and then is transmitted to the portable cellular phone 16 through the base station 15. As a wireless communication between the portable cellular phone 16 and the base station 15, the radio packet communication system being a part of the standard specifications (RCR-STD-27H) of portable cellular phones.

First, a packet paging signal is transmitted from the switching center 13 to the portable cellular phone 16 through the base station 15 (Step S8). To connect a packet communication line between the portable cellular phone 16 and the switching center 13, a packet registration requesting signal is transmitted from the portable cellular phone 16 to the switching center 13 through the base station 15 (Step S9). Then, a packet authentication requesting signal is transmitted from the switching center 13 to the portable cellular phone 16 through the base station 15 (Step S10) and a packet authentication acknowledgement signal is transmitted from the portable cellular phone 16 to the switching center 13 through the base station 15 (Step S11). A packet registration acknowledgement signal is transmitted from the switching center 13 to the portable cellular phone 16 through the base station 15 (Step S12). After the radio packet communication line has been connected between the portable cellular phone 16 and the switching center 13 through the base station 15 by a series of these procedures to enable a transmission and/or receipt of data, the voice message arrival notifying signal received by the switching center 13 at Step S7 is transmitted, as data for the radio packet communication line, to the portable cellular phone 16 (Step S13).

Then, a packet communication disconnecting request signal is transmitted from the switching center 13 to the portable cellular phone 16 (Step S14) and a packet communication disconnection acknowledgement signal is transmitted from the portable cellular phone 16 to the switching center 13 (Step S15). The radio packet communication line between the portable cellular phone 16 and the switching center 13 is disconnected. The portable cellular phone 16 having received the voice message arrival notifying signal at Step S13 recognizes that the voice message to be fed to the portable cellular phone 16 has been stored in the voice server 14 and notifies, by a special signal sound, flashing display of an LED (Light Emitting Diode), display of an LCD (Liquid Crystal Display) device or a like, the user of the portable cellular phone 16 of the accumulation of the voice message in the voice server 14 (that is, processing of transmitting the voice message arrival notifying signal is performed). Thus, the user of the portable cellular phone 16 need not use speech channels to check whether the voice message has been accumulated and, as a result, no increase in traffic occurs.

In a data format of the voice message arrival notifying signal is stored, for example, as shown in FIG. 4, the information about a caller (that is, the user of the telephone set 11) including (1) a control number (serial number) of the voice message stored in the voice server 14 (2) time when the voice message was stored (3) a subscriber number (telephone number) of a registrant of the voice message (4) a name of the registrant of the voice message or a like, which are displayed in the LCD section 16e of the portable cellular phone 16. This enables the user of the portable cellular phone 16 to identify the caller or originator of the voice message.

Moreover, when the portable cellular phone 16 is placed out of the service area, though there is a case where the portable cellular phone 16 cannot receive the voice message arrival notifying signal at a time when the voice message notifying signal is transmitted from the voice server 14, however, if the voice message arrival notifying signal has not reached the portable cellular phone 16, by re-transmitting the voice message arrival notifying signal at every specified time, from the voice server 14, the portable cellular phone 16 can surely receive the notification signal, so long as a frequency of its use is not small.

As described above, in the portable cellular phone system of the embodiment, if the portable cellular phone 16 is placed out of the service area and cannot receive the voice message, after the voice message to be fed to the portable cellular phone 16 has been stored in the voice server 14, when the portable cellular phone 16 has moved into the service area, the voice message arrival notifying signal is transmitted by using the radio packet communication system and, therefore, the user of the portable cellular phone 16 can check whether the voice message has been accumulated or not in the voice server 14 without using the ordinary speech channels. This prevents the speech channels from being increased, thus enabling efficient use of the speech channels. Furthermore, since information about the caller is contained in the voice message arrival notifying signal and the information about the caller is displayed in the LCD section 16e, the user of the portable cellular phone 16 can easily identify a party who has sent out the voice message.

It is apparent that the present invention is not limited to the above embodiments but may be changed and modified without departing from the scope and spirit of the invention. For example, the portable cellular phone may be constructed in an arbitrary manner so long as it has functions of receiving the voice message arrival notifying signal transmitted by using the radio packet communication system and of displaying the contents of the voice message notifying signal including information of the party who has sent out the voice message. Moreover, the data format of the voice message arrival notifying signal may include, for example, arbitrary information such as information about an organization or department to which the registrant of the voice message belongs or a like.

What is claimed is:

1. A portable cellular phone system enabling a user of a portable cellular phone to make use of a stored-type voice message service comprising:
units to store, when connection with said portable cellular phone is unable to be made, a voice message to be fed to said portable cellular phone and to provide, when connection with said portable cellular phone is able to be made, a notification that said voice message has been stored, to said portable cellular phone.

2. The portable cellular phone system according to claim 1, wherein said notification that said voice message has been stored is provided to said portable cellular phone by using a radio packet communication system.

3. A portable cellular phone system enabling a user of a portable cellular phone to make use of a stored-type voice message service comprising:
a telephone set used to send out a voice message to be fed to a user of said portable cellular phone by a manipulation of a caller of said telephone set;
a dialup line used to transmit said voice message;
a switching center used to transmit, when connection with said portable cellular phone is unable to be made, said voice message fed through said dialup line to a voice message storing device and to send out, when connection with said portable cellular phone is able to be made, a voice message arrival notifying signal informing that said voice message has been stored, by reading it from said voice message storing device;
said voice message storing device used to store said voice message transmitted from said switching center and to send out said voice message arrival notifying signal;
a base station used to send out said voice message arrival notifying signal fed from said switching center to said portable cellular phone; and
said portable cellular phone used to receive said voice message arrival notifying signal and to notify said user of said portable cellular phone of receipt of said voice message arrival notifying signal.

4. The portable cellular phone system according to claim 3, wherein said base station is so configured as to send out said voice message arrival notifying signal fed from said switching center to said portable cellular phone by using a radio packet communication system.

5. The portable cellular phone system according to claim 3, wherein said voice message arrival notifying signal contains information about a caller and said portable cellular phone has a function to display said information about said caller.

6. A method for controlling a portable cellular phone system enabling a user of a portable cellular phone to make use of a stored-type voice message service comprising:
steps of storing, when connection with said portable cellular phone is unable to be made, a voice message to be fed to said portable cellular phone and of providing, when connection with said portable cellular phone is able to be made, a notification that said voice message has been stored, to said portable cellular phone.

7. A method for controlling a portable cellular phone system enabling a user of a portable cellular phone to make use of a stored-type voice message service comprising:
a voice message sending process of sending out a voice message to be fed to a user of said portable cellular phone by a manipulation of a caller of a telephone set;
a voice message transmitting process of transmitting said voice message;
a switching process of transmitting, when connection with said portable cellular phone is unable to be made, said voice message fed by said voice message transmitting process, to a voice message storing device and of sending out, when connection with said portable cellular phone is able to be made, a voice message arrival notifying signal informing that saidvoicemessage has been stored, by reading it from said voice message storing device;
a voice message storing process of storing said voice message fed by said switching process and of sending out said voice message arrival notifying signal;
a packet transmitting process of transmitting said voice message arrival notifying signal fed by said switching process to said portable cellular phone; and
a voice message arrival notifying process of receiving said voice message arrival notifying signal and of notifying said user of said portable cellular phone of receipt of said voice message arrival notifying signal.

8. The method for controlling the portable cellular phone according to claim 7, wherein said packet transmitting process is a process of sending out said voice message arrival notifying signal fed by said switching process to said portable cellular phone by using a radio packet communication system.

9. The method for controlling the portable cellular phone according to claim 7, wherein said voice message arrival notifying signal contains information about a caller and said voice message arrival notifying process contains a process of displaying said information about said caller.

10. A storage medium storing a program for causing a computer to execute functions of a portable cellular phone system enabling a user of a portable cellular phone to make use of a stored-type voice message service, said portable cellular phone system comprising:
units to store, when connection with said portable cellular phone is unable to be made, a voice message to be fed to said portable cellular phone and to provide, when connection with said portable cellular phone is able to be made, a notification that said voice message has been stored, to said portable cellular phone.

11. A storage medium storing a program for causing a computer to execute functions of a portable cellular phone system enabling a user of a portable cellular phone to make use of a stored-type voice message service, said portable cellular phone system comprising:
a telephone set used to send out a voice message to be fed to a user of said portable cellular phone by a manipulation of a caller of said telephone set;
a dialup line used to transmit said voice message;
a switching center used to transmit, when connection with said portable cellular phone is unable to be made, said voice message fed through said dialup line to a voice message storing device and to send out, when connection with said portable cellular phone is able to be made, a voice message arrival notifying signal informing that said voice message has been stored, by reading it from said voice message storing device;
said voice message storing device used to store said voice message transmitted from said switching center and to send out said voice message arrival notifying signal;
a base station used to send out said voice message arrival notifying signal fed from said switching center to said portable cellular phone; and
said portable cellular phone used to receive said voice message arrival notifying signal and to notify said user of said portable cellular phone of receipt of said voice message arrival notifying signal.
